(19) United States
(12) Patent Application Publication
(10) Pub. No.: US 2013/0122252 A1
(43) Pub. Date: May 16, 2013

(54) ION BEAM DEPOSITION OF FLUORINE-BASED OPTICAL FILMS

(71) Applicant: VEECO INSTRUMENTS, INC., Plainview, NY (US)

(72) Inventors: Aiko Ode, Longmont, CO (US); Jason George, Fort Collins, CO (US); Leonard Joseph Mahoney, Fort Collins, CO (US)

(73) Assignee: VEECO INSTRUMENTS, INC., Plainview, NY (US)

(21) Appl. No.: 13/674,709

(22) Filed: Nov. 12, 2012

Related U.S. Application Data
(60) Provisional application No. 61/558,853, filed on Nov. 11, 2011.

(51) Int. Cl. G02B 1/11

(52) U.S. Cl. CPC G02B 1/113
USPC 428/141; 204/192.11; 204/298.04

(57) ABSTRACT

The presently disclosed technology uses dissociated fluorine and one or both of hydrogen and oxygen to assist the deposition of metal-fluoride thin films having low optical losses using ion sputter deposition. The dissociated fluorine and one or both of hydrogen and oxygen are injected into an enclosure within which the sputter deposition operations occur. The dissociated fluorine and one or both of hydrogen and oxygen assist the sputtering of metal-fluoride material from a target and/or deposition of the sputtered metal-fluoride on one or more substrates.

### CROSS-REFERENCE TO RELATED APPLICATIONS

The present application claims benefit of priority to U.S. Provisional Patent Application No. 61/558,853, entitled “Ion Beam Deposition of Fluorine-Based Optical Films” and filed on 11 Nov. 2011, which is specifically incorporated by reference herein for all that it discloses or teaches. The present application is related to International Patent Application No. ______, entitled “Ion Beam Deposition of Fluorine-Based Optical Films” and filed on 12 Nov. 2012, which is also specifically incorporated by reference herein for all that it discloses or teaches.

### BACKGROUND

Fluorine-based optical thin films (e.g., MgF₂, LaF₃, AlF₃, HfF₄, GdF₃, YF₃, and LiF₃) are used in the fabrication of optical coatings, as an example for ultraviolet (UV) and vacuum ultraviolet (VUV) antireflection (AR) coatings. These AR coatings may be produced by depositing layers of thin film materials with alternating high and low indices of refraction on an optical substrate. Typically, the optical film layers are deposited by electron beam (e-beam) evaporation or ion beam assisted deposition (IBAD) evaporation. However, in other implementations, the optical film layers may be deposited using sputter deposition, such as ion beam sputtering or dual ion beam sputtering, or magnetron sputter deposition.

Often, the fluorine-based optical films are evaporated or sputtered from a bulk sample or target of the fluorine-based compound. However, when using sputter deposition to deposit the fluorine-based optical films, there can be a deficiency of fluorine concentration in the deposited film stoichiometry, as compared to using e-beam evaporation. As a result, e-beam evaporation has been a preferred method of depositing the fluorine-based optical films.

However, with sufficient fluorine concentration in the deposited film stoichiometry, it may be desirable to utilize sputter deposition rather than e-beam evaporation. When compared to e-beam evaporation, thin films produced with ion beam sputter deposition may have a higher degree of material packing density, less granularity in morphology, and higher surface smoothness. As such, the optical performance of thin films deposited by ion beam sputtering may exhibit less optical losses than thin films produced by e-beam evaporation methods. Moreover, the denser optical films produced by ion beam sputter deposition may be more environmentally stable and have higher endurance in optical applications.

### SUMMARY

Implementations described and claimed herein address the foregoing problems by providing a method comprising depositing an ion sputtered metal-fluoride coating on a substrate in the presence of dissociated fluorine and at least one of hydrogen and oxygen.

Implementations described and claimed herein further address the foregoing problems by providing a metal-fluoride coating ion sputtered onto a substrate in the presence of dissociated fluorine and at least one of hydrogen and oxygen, wherein the ion metal-fluoride coating has a surface roughness increase of less than 10 Å RMS.

Implementations described and claimed herein further still address the foregoing problems by providing an ion sputtering system comprising: a process gas source that injects dissociated fluorine and at least one of hydrogen and oxygen into an enclosure; and a substrate within the enclosure that receives a sputtered metal-fluoride coating.

Other implementations are also described and recited herein.

### BRIEF DESCRIPTIONS OF THE DRAWINGS

FIG. 1 illustrates a block diagram of an example hydrogen/oxygen assisted ion beam sputter deposition system.

FIG. 2 illustrates an example implementation of a hydrogen/oxygen assisted ion beam sputter deposition system.

FIG. 3 illustrates an example spectral transmission scan of an AlF₃ single-layer film deposited over a fused quartz substrate using a water-assisted ion beam sputter deposition system.

FIG. 4 illustrates an example spectral transmission scan of a LaF₃ single-layer film deposited over a fused quartz substrate using a water-assisted ion beam sputter deposition system.

FIG. 5 illustrates an example spectral transmission scan of an AlF₃/LaF₃ AR film deposited on both sides of a fused quartz substrate using a water-assisted ion beam sputter deposition system.

FIG. 6 illustrates example operations for assisting the deposition of fluorine-based optical thin films using dissociated fluorine and one or both of hydrogen and oxygen.

### DETAILED DESCRIPTIONS

In ion beam sputtered deposition systems, a beam of ions from an ion source strikes a target with such kinetic energy to sputter atoms of a desired material off from the target into a plume, which can subsequently deposit these atoms of desired material on a substrate.

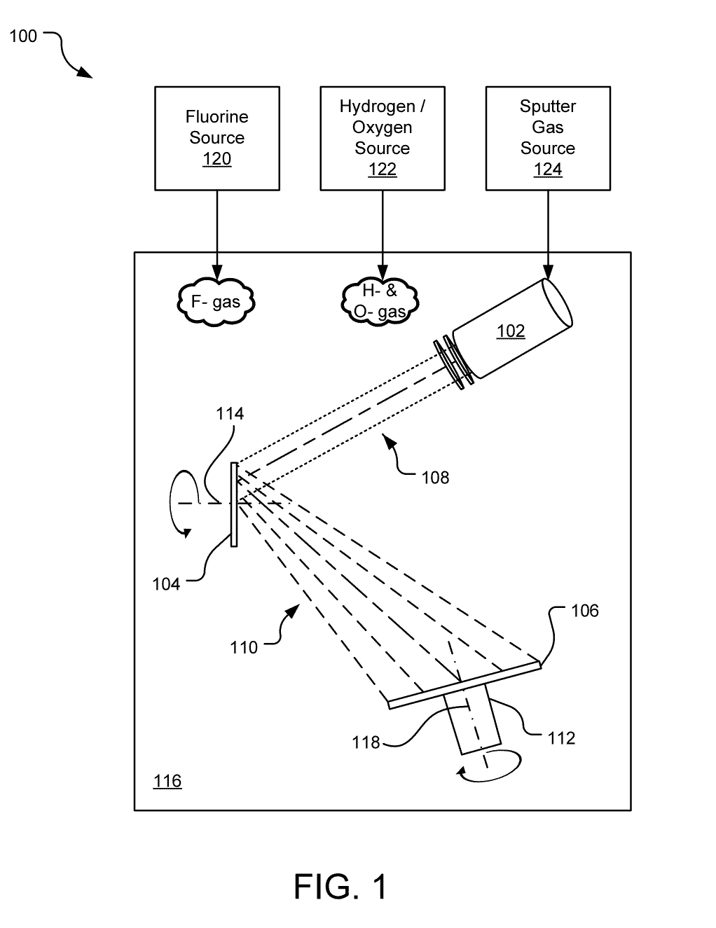

FIG. 1 illustrates a block diagram of an example hydrogen/oxygen assisted ion beam sputter deposition system 100. Even though the implementation of the ion sputter system 100 is implemented as an ion beam sputter deposition system, the presently disclosed technology may also apply to other types of sputter deposition systems and/or e-beam evaporation systems that are used to produce fluorine-based optical films (e.g., GdF₃, MgF₂, LaF₃, AlF₃, HfF₄, YF₃, and LiF₃). Fluorine-based optical films as referenced herein include metal-fluoride films and metal-oxy-fluoride films, for example. The presently disclosed technology may be used to produce fluorine-based optical films that are low-loss in the UV and VUV ranges. The presently disclosed technology may also apply to optical coatings that provide low-loss properties in other wavelength ranges.

In the illustrated implementation, the ion sputter system 100 includes an ion source 102, a target assembly 104, and a substrate assembly 106 within an enclosure 116. The ion source 102 generates an ion beam 108 targeted or directed toward the target assembly 104. The ion source 102 may be a DC type, a radio frequency (RF) type or a microwave type gridded ion source, for example. Further, ion sputter gas (typically an inert gas such as Ar, Kr, or Xe) may be provided to the ion source 102 via a sputter gas source 124. Specifically, the ion sputter gas is injected into the ion source 102 where it is first ionized by a gas discharge or plasma. The ions within the ion source 102 are then accelerated by a set of ion beam grid optics at the output of the ion source 102 in order to form the ion beam 108.

The target assembly 104 may be rotated or moved in a desired manner, including rotation of the target assembly 104 about its axis 114 or pivoting the target assembly 104 to tilt the target assembly 104 to alter its angle with respect to the ion beam 108. The ion beam 108, upon striking the target assembly 104, generates a sputter plume 110 of material from one or more individual targets (not shown) affixed to the target assembly 104.

The ion beam 108 strikes the target assembly 104 at such an angle that the sputter plume 110 generated from the target assembly 104 travels towards the substrate assembly 106. In one implementation of the ion sputter system 100, the sputter plume 110 is divergent as it travels towards the substrate assembly 106 and may partially overspray the substrate assembly 106. In another implementation, the sputter plume 110 may be made more or less concentrated so that its resulting deposition of material is directed over a particular area of the substrate assembly 106.

The substrate assembly 106 may refer to a single large substrate or a sub-assembly holder that holds multiple smaller individual substrates (not shown). In one example implementation of the ion sputter system 100, the substrate assembly 106 is attached to a fixture 112 that allows the substrate assembly 106 to be rotated or moved in a desired manner, including rotation of the substrate assembly 106 about its axis 118 or pivoting the fixture 112 to tilt the substrate assembly 106 to alter its angle with respect to the sputter plume 110.

The substrate(s) may be substantially planar (e.g., wafers and optical lenses or flats) or have various 3-D features (e.g., cubic (or faceted) optical crystals, curved optical lenses, and cutting tool inserts). In addition, the substrate(s) may be masked with mechanical templates or patterned etch resist layers (e.g., photo-resist) to help facilitate selected patterning of deposited films over the surface areas of the substrate(s).

The enclosure 116 is a controlled gaseous environment within which the ion deposition system 100 operates. Using a vacuum or near-vacuum within the enclosure 116 may yield fluorine-based deposited film(s) with too much absorption for a desired ultraviolet optical thin-film coating application. This absorption may be attributed to a stoichiometric reduction of fluorine in the deposited film(s) as compared to, for example, a fully stoichiometric metal-fluoride target material that is being sputtered. One potential cause of the fluorine deficiency in the deposited film(s) is that the various atomic or molecular elements of the target assembly 104 surface will be sputtered at different relative rates or yields when impacted by the incident ion beam 108. This physical phenomenon is often referred to as differential sputtering. Also different sputtered atomic or molecular elements will have different distribution of ejection angles off the target assembly 104 for a given incident ion beam angle. As a result, the flux of material arriving from the sputter plume 110 onto the substrate assembly 106 may not condense or deposit films with the same stoichiometric composition as the sputter target assembly 104. When ion beam sputtering metal-fluoride materials, differential sputtering can result in deposited optical films that are stoichiometrically depleted of fluorine. This depletion in fluorine in the ion beam deposited metal-fluoride deposited thin film can contribute to optical losses in the deposited thin film, particularly in the ultra-violet range.

In order to counteract the depletion of fluorine, a partial pressure or added concentration of gaseous compounds may be injected into the enclosure 116 to assist the deposition process. For example, a gaseous reactive fluorine carrier (e.g., F₂, NF₃, and CF₄) may be added to the enclosure 116 via a fluorine source 120 to provide additional reactive fluorine (fluoride or F—) to the plume 110. F— as used here indicates unbound radical species (i.e., F₁ or F) of fluorine. Further, radical ion states of fluorine (i.e., F⁻) may also be added to the enclosure 116 via the fluorine source 120.

This may help to obviate the aforementioned deficiency or depletion of fluorine concentration in the deposited film stoichiometry when using sputter depositions systems like the ion sputter system 100. Further, the additional gaseous reactive fluorine carrier may also improve the morphologic or optical properties of the fluorine-based optical films deposited on the substrate assembly 106.

In some implementations, NF₃ or CF₄ may be used over F₂ as a gaseous reactive fluorine carrier due to the highly toxic nature of F₂. However, even the use of NF₃ or CF₄ alone may generate toxic gasses within the enclosure 116 as they can be dissociated and eventually form either free fluorine (F—) or F₂. More specifically, dissociation of either F₂, NF₃, or CF₄ may create F— atoms that attach to surfaces within the enclosure 116 and volatize as HF vapor when the ion sputter system 100 is vented to atmosphere (e.g., when substrates are loaded/unloaded from the ion sputter system 100). These localized concentrations of HF may exceed 1 ppm (parts per million) and thus could create a localized hazard to nearby personnel. Due to such safety hazards, practitioners may have to use personal protection equipment (e.g., air purifying respirators and protective clothing) before safely loading/unloading the ion beam sputter system 100. Further, the practitioners may have to vent the vacuum-based ion beam sputter system 100 gradually and iteratively in order to dilute the evolving HF vapor concentrations to safe concentration levels.

A hydrogen/oxygen carrier (e.g., H₂O) may also be added to the enclosure 116 via a hydrogen/oxygen source 122 to add reactive hydrogen (H—) and/or oxygen (O—) that further reduces optical absorption. H— and O— as used here indicate unbound radical species of hydrogen and oxygen, respectively. Further, radical ion states of hydrogen and oxygen (i.e., i.e., H⁺ or O⁻²) may also be added to the enclosure 116 via the hydrogen/oxygen source 122. Other example hydrogen/oxygen carriers include H₂O₂ and H₂ and O₂ gasses.

In implementations where the hydrogen/oxygen carrier is combined with the fluorine carrier, the presence of HF vapors within the enclosure 116 when vented to atmosphere may be reduced to a concentration where there is no significant risk to nearby personnel and to levels where personal protection equipment or cycled venting is not warranted. This may be attributed to the F— atoms bonding with the hydrogen component of the hydrogen/oxygen carrier to form volatile HF during deposition of the fluorine-based films and prior to venting the enclosure 116 to atmosphere. The volatile HF may then be consumed as a fluorine source for the ion beam 108, the sputter plume 110, and/or the substrate assembly 106.

In one implementation of the ion sputter system 100, the one or more targets affixed to the target assembly 114 are made of a single material or of different materials that may be placed and interchanged on the target assembly 114. The different target materials (e.g., various metal-fluorides and/or metallic alloys) allow layers of different materials to be deposited on the substrate(s) on the substrate assembly 106 to create multi-layer coatings. Examples of such materials to be deposited on the substrates include without limitation metal-fluorides (e.g., MgF₂, LaF₃, AlF₃, HfF₄, GdF₃, YF₃, and LiF₃).

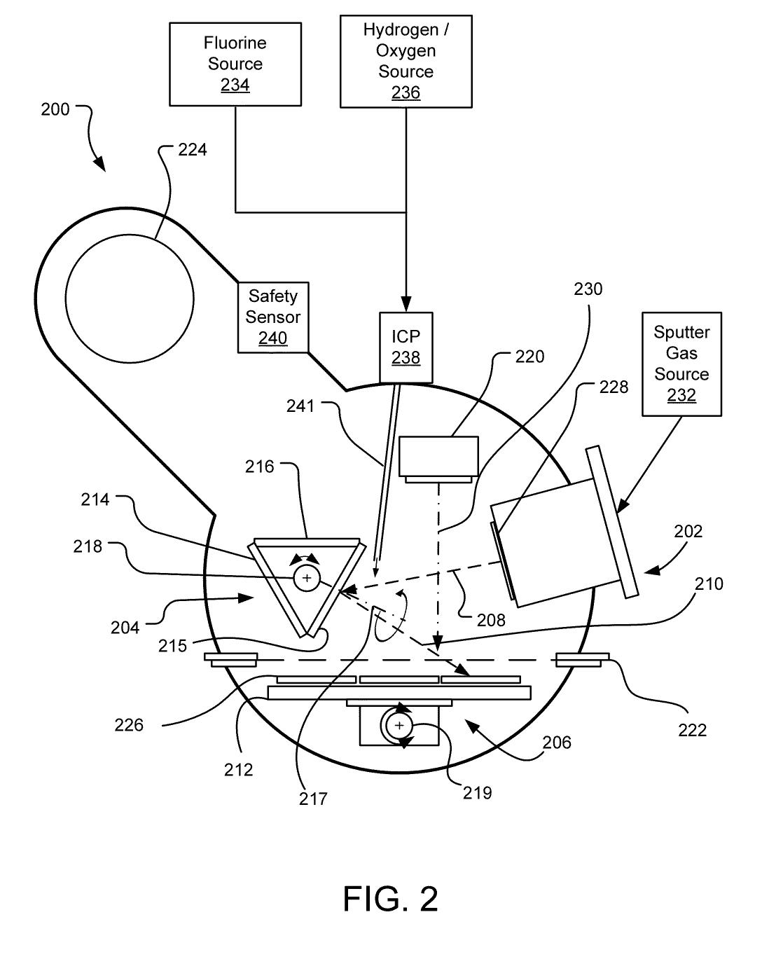

FIG. 2 illustrates an example implementation of a hydrogen/oxygen assisted ion beam sputter deposition system 200. More specifically, the sputter deposition system 200 is a dual ion beam sputter deposition system. The sputter deposition system 200 includes a main radio frequency antennae (RF) ion source 202, a target assembly 204, and a substrate assembly 206. The substrate assembly 206 may be tilted about a shaft 219. The main ion source 202 generates an ion-beam 208 that is directed toward the target assembly 204. In one implementation, the main ion source 202 has three grids with a beam current ranging from 100-1000 mA, beam voltages ranging between +150V and +1500V, and grid voltages ranging between −100V and −1000V. Further, the ion-beam 208 may have an approximately circular cross section.

Further, ion sputter gas (e.g., Ar, Kr, Ne, Xe, or any combination thereof) may be provided to the main ion source 202 via a sputter gas source 232. The sputter gases are ionized within the main ion source 202 to form a discharge or plasma (not shown) and the ions are then extracted from the main ion source 202 to form an ion beam 208. The target assembly 204, upon interaction with the ion beam 208, generates a sputter plume 210 that deposits a desired material on one or more substrates (e.g., substrate 226) of the substrate assembly 206.

The sputter deposition system 200 may include a chamber door 222 to access the contents of the sputter deposition system 200, when open. The chamber door 222 maintains vacuum conditions in the sputter deposition system 200, when closed (as illustrated). Further, the sputter deposition system 200 may include a load-lock system that allows the substrate assembly 206 to be changed while the system 200 remains under vacuum conditions (e.g., without opening the chamber door 222). In one implementation, the substrate(s) are made of a single or arrayed batch of substantially planar wafers or optical lenses or flats. Further, the substrate(s) may have additional 3D features, such as cubic (or faceted) optical crystals or curved optical lenses, for example. In addition, the substrate(s) may be masked with mechanical templates or patterned etch resist layers (e.g., photo-resist) to help facilitate selected patterning of deposited films or ion treatment over the surface areas of the substrate(s).

The target assembly 204 includes a plurality of targets 214, 215, 216. Other systems may include fewer or greater numbers of targets. In one implementation, the target assembly 204 rotates about a shaft 218 to expose a selected target to the ion beam 208. Further, each of the targets 214, 215, 216 may include the same or different materials for sputtering. Still further, the orientation of the selected target (e.g., target 215) can be varied during deposition to help distribute wear across the target assembly 204 and the substrate assembly 206, and to improve deposition uniformity. Further, each of the targets 214, 215, 216 may be rotated (e.g., target 215 around an axis 217) in some implementations. Each of the targets 214, 215, 216 may be made of a high purity fluorine-based metallic compound or a fluoride-reactive metal (e.g., MgF₂, AlF₃, Al, Gd, and LaF₃).

Further, an assist RF ion-source 220 may assist the deposition of the sputter plume 210 on the substrate assembly 206. In one implementation of the sputter deposition system 200, a gating mechanism (not shown) is used to manage the amount and location of the deposition of the sputter plume 210 on the substrate assembly 206. In one example implementation, the assist ion source 220 generates an ion beam 230 that is directed toward the substrate assembly 206. The ion beam 230 may be used to either pre-clean or pre-heat the surface of the substrate(s), for example. In another implementation, the assisting ion beam 230 is used in combination with the sputter plume 210 to enhance deposition performance (e.g., increase material deposition density, increase surface smoothness, reduce oxidation, reduce nitridation, etc.) on the substrate assembly 206. The assist ion source 220 may be operated using one or more of an inert gas (e.g., Ar, Kr, Xe, Ne, and/or He), a fluorine carrier gas (see above), and/or hydrogen/oxygen (see above) depending on its particular use (e.g., pre-clean, pre-heat, and/or assist).

A safety sensor 240 may be included in the sputter deposition system 200 that detects whether sufficient levels of toxic gasses (e.g., F₂ and HF) are present within the system 200 that may pose a safety risk to nearby personnel if the sputter deposition system 200 is vented to atmosphere. The safety sensor 240 may be tied to an indicator (not shown) to warn personnel of a safety risk and/or a lock (not shown) to prevent the sputter deposition system 200 from being opened when there is a safety risk. An implementation of the sputter deposition system 200 is provided with a vacuum system pump and plenum 224 to generate and maintain a vacuum or near-vacuum condition inside the ion beam system 200. Further, desired concentrations of gaseous compounds or elements (e.g., fluorine, hydrogen and/or oxygen) may be added to the evacuated sputter deposition system 200 to assist the deposition process.

For example, a gaseous reactive fluorine carrier (e.g., F₂, NF₃, CF₄, or any combination thereof) may be added to the sputter deposition system 200 via a gaseous fluorine source 234 to provide additional fluorine to the sputter plume 210. In one implementation, the gaseous reactive fluorine carrier is added at a rate of about 5-30 sccm using a mass flow controller. This may help to obviate the aforementioned deficiency of fluorine concentration in the deposited film stoichiometry when using the sputter deposition system 200. Further, the additional gaseous reactive fluorine carrier may also improve the optical properties of fluorine-based optical films deposited on the substrate assembly 206. The fluorine carrier gas may be introduced into the deposition system 200 directly or through a secondary remote plasma (or ICP) source 238.

A hydrogen/oxygen carrier (e.g., vaporized H₂O) may also be added to the sputter deposition system 200 via a hydrogen/oxygen source 236 to add reactive hydrogen (H+) and/or oxygen (O—) that further reduces optical absorption of the deposited optical film. In an implementation utilizing vaporized H₂O as the hydrogen/oxygen carrier, the H₂O may be supplied using a mass flow controller to measure the H₂O, and/or metering valves to control the flow of the H₂O vapor in the range of about 5 sccm to about 50 sccm. In one implementation, the partial pressure of the H₂O ranges between about 0.1 mTorr to about 0.5 mTorr. In an implementation utilizing both the fluorine carrier and the hydrogen/oxygen carrier, the operating pressure of the combined carrier gas flow may range from about 0.3 mTorr to about 1.0 mTorr, for example.

In order to make the fluorine carrier and the hydrogen/oxygen carrier more reactive, the fluorine carrier and the hydrogen/oxygen carrier may be passed through the remote plasma source 238 that dissociates the fluorine carrier and the hydrogen/oxygen carrier into more reactive atomic or radicalized molecular constituents (e.g., F—, NF—, NF₂—, OH—, and O—) and/or ionized constituents (e.g., F, O⁻², OH⁻). The reactive atomic or radicalized molecular constituents of the fluorine carrier and the hydrogen/oxygen carrier may more successfully interact with the ion beam 208, the target assembly 204, the sputter plume 210, and/or the substrate assembly 206, as compared to the more stable forms of the fluorine carrier and the hydrogen/oxygen carrier.

In addition to the fluorine and hydrogen/oxygen carrier gases (e.g., F₂, NF₃, CF₄ and H₂O) discussed above, an inert gas source (not shown) may add a small amount (e.g., up to 20% of the fluorine carrier gas volume or 3-5 sccm) of inert gas (e.g., Ar, Ne, He, Kr, and/or Xe) to the remote plasma source 238 in order to seed the plasma discharge and thereby make dissociation of the carrier gases more efficient. It may also make starting of the remote plasma source 238 easier and/or its operation more stable.

Further, the fluorine and/or the hydrogen/oxygen carrier gas may directed toward a desired region of the sputter deposition system 200 (e.g., where the ion beam 208 impinges on the target assembly 204 or wherein the sputter plume 210 impinges on the substrate assembly 206) via a directing tube 241 The directing tube 241 may be made of any convenient material (e.g., metallic alloys or ceramics such as Al₂O₃) and have any appropriate shape and size. In other implementations, there is no directing tube 241 and the fluorine and/or the hydrogen/oxygen carrier gas is distributed effectively throughout the sputter deposition system 200 without being directed to a specific location within the sputter deposition system 200.

In some implementations, NF₃ and/or CF₄ may be used over F₂ due to the highly toxic nature of F₂. However, even the use of NF₃ and/or CF₄ may generate toxic gasses within the sputter deposition system 200 as they can be dissociated and eventually form either free fluorine (F—) or F₂. More specifically, the dissociation of F₂, NF₃, and/or CF₄ using the remote plasma source 238 may create F— atoms that attach to interior surfaces of the sputter deposition system 200 and volatize as HF when the sputter deposition system 200 is vented to atmosphere (e.g., when substrates are loaded/unloaded from the sputter deposition system 200). These localized concentrations of HF may exceed 1 ppm and thus could create a localized hazard to nearby personnel.

In implementations where the hydrogen/oxygen carrier is combined with the fluorine carrier, the presence of HF vapors within the sputter deposition system 200 when vented to atmosphere may be reduced to a level where there is no significant risk to nearby personnel and no personal protection equipment is required or additional cycled-venting measures are required in order to dilute evolving HF vapor concentrations within the deposition system 200. This may be attributed to the F— atoms bonding with the hydrogen component of the hydrogen/oxygen carrier to form volatile HF during deposition and prior to venting the sputter deposition system 200 to atmosphere. The volatile HF may then be consumed as a fluorine source for the ion beam 208, the sputter plume 210, and/or the substrate assembly 206.

In an example implementation, the inclusion of dissociated NF₃ and H₂O in an ion beam sputter deposition system (e.g., system 200) reduces optical loss so that greater than 99.0% transmission is achieved using a 3-layer AR coating of LaF₃/AlF₃ or GdF₃/AlF₃ deposited on a fused-silica or CaF₂ substrate at UV spectral line of about 193 nm. Further, in this example implementation, most of the highly toxic F₂ and HF vapor concentrations are absent when venting, so long as H₂O is injected during deposition of the fluorine-based optical thin films.

In an example implementation using a load-lock substrate configuration, an AlF₃ single-layer film deposited at a rate of about 3.2 angstroms per second achieves a refractive index of about 1.42 at 193 nm, and a GdF₃ single-layer film deposited at a rate of about 1.6 angstroms per second achieves a refractive index of about 1.64 at 193 nm. An AR coating of both these AlF₃ and GdF₃ films together achieved a transmittance of about 99.0% and a reflectance of about 0.05% at 193 nm. A high-reflection (HR) coating of the AlF₃ and GdF₃ films together achieved a reflectance of about 97.5% and transmittance of about 0.06% at 193 nm.

In an example implementation using a batch configuration, an AlF₃ single-layer film deposited at a rate of about 2.7 angstroms per second achieves a refractive index of about 1.39 at 193 nm, and a LaF₃ single-layer film deposited at a rate of about 1.3 angstroms per second achieved a refractive index of about 1.67 at 193 nm. An AR coating of both these AlF₃ and LaF₃ films together achieved a transmittance of about 99.0% and a reflectance of about 0.24% at 193 nm. A high-reflection (HR) coating of the AlF₃ and GdF₃ films together achieved a reflectance of about 97.3% and a transmittance of about 0.2% at 193 nm.

Optical losses in optical thin films are dependent on the wavelength of the light being transmitted through the film and are due to a number of factors including absorption (which is dependent on the film chemical composition/stoichiometry), scattering of light due to crystal structure/morphology, and/or defect density within the film and scattering at the surface (which is due to surface roughness and may be an indicator of film morphology and/or defect density within the film layer). In particular, scattering losses can become increasingly significant at lower wavelengths, for example at UV wavelengths less than 250 nm. Surface smoothness is an important parameter that correlates with low scattering losses in optical thin films.

One method of characterizing surface smoothness is to measure the surface roughness before and after film deposition on a super polished substrate (i.e., a substrate with roughness less than about 1 Å RMS). An increase in surface roughness correlates with scattering losses with a lower roughness increase being associated with lower scattering losses. In one implementation, evaporated coatings are observed as having a milky appearance under bright visible lighting, which typically correlates to a surface roughness greater than about 10 Å RMS. The ion beam deposited coatings disclosed herein may have a clear and transparent appearance, which correlates with a surface roughness of less than about 10 Å RMS.

An analysis of increase in surface roughness (compared to an uncoated substrate) of one or more of the aforementioned AlF₃ and GdF₃, single-layer films shows the following results. The increase in surface roughness change of the AlF₃ single-layer film ranges from about 5 Å to 6 Å RMS over the uncoated substrate. The GdF₃ single-layer film showed no detectable change in surface roughness within the measurement resolution (i.e., less than about 0.2 Å RMS, or +/−10% for roughness features less than 2 nm tall). Surface roughness measurements were also made of both 2 and 3 layer AR coatings of various combinations of AlF₃—GdF₃ and AlF₃—LaF₃. The surface roughness change of these multi-layer AR coatings was in the range of about 0.2 Å to 0.5 Å RMS.

A surface and sub-surface stoichiometric analysis of the aforementioned AlF₃ and LaF₃ single-layer films shows the following results. The surface of the AlF₃ single-layer film shows about 56.5% fluorine, about 19.3% aluminum, about 13.3% oxygen, and about 9.5% carbon. The fluorine to aluminum ratio of the surface of the AlF₃ single-layer film is about 2.93%. The sub-surface of the AlF₃ single-layer film shows about 61.4% fluorine, about 23.7% aluminum, about 13.0% oxygen, and about 0.3% carbon. The fluorine to aluminum ratio of the surface of the AlF₃ single-layer film is about 2.59%. The carbon content on the surface of the AlF₃ single-layer film may be attributed to surface contamination.

The surface of the LaF₃ single-layer film shows about 56.1% fluorine, about 21.6% lanthanum, about 13.5% oxygen, and about 8.7% carbon. The fluorine to lanthanum ratio of the surface of the LaF₃ single-layer film is about 2.60%. The sub-surface of the LaF₃ single-layer film shows about 55.2% fluorine, about 34.0% lanthanum, about 10.4% oxygen, and about 0.0% carbon. The fluorine to lanthanum ratio of the surface of the LaF₃ single-layer film is about 1.62%. The carbon content on the surface of the LaF₃ single-layer film may be attributed to surface contamination. The aforementioned percentages are as observed by x-ray photoelectron spectroscopy, which indicates the approximate atomic percentages of the aforementioned elements.

A GdF₃ single-layer film may have similar surface and/or sub-surface stoichiometric characteristics as described above with regard to one or both of the LaF₃ single-layer film and the AlF₃ single-layer film.

For low loss optical applications, particularly in the UV range, the presence of oxygen in the film may increase light absorption. However, even with relatively high oxygen content, the aforementioned films have relatively low overall loss. This may be due to the, low surface roughness characteristic, which makes the films disclosed herein useful for UV AR coatings and demonstrates the feasibility of the deposition process for other applications. More specifically, the metal-oxy-fluoride films disclosed herein may be useful for other non-optical applications due to their mechanical, electrical and dielectrical properties.

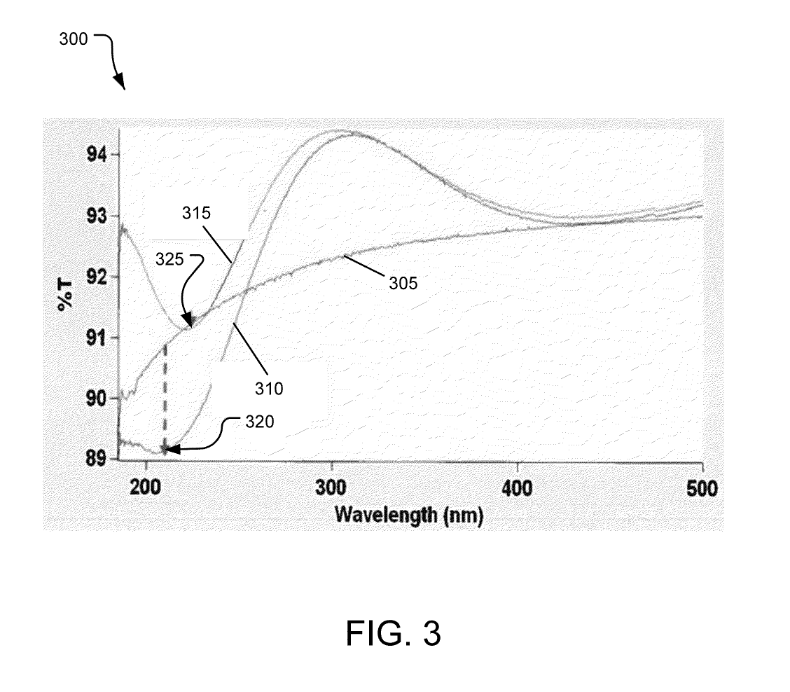

FIG. 3 illustrates an example spectral transmission scan 300 of an AlF₃ single-layer film deposited over a fused quartz (i.e., silica) substrate using a water-assisted ion beam sputter deposition system. During the deposition of the AlF₃ single-layer film, H₂O vapor flows through an ion source at about 10-20 sccm. The deposited AlF₃ film thickness is about 40-60 nm.

Curve 305 illustrates the spectral transmission of the uncoated quartz substrate, curve 310 illustrates the AlF₃ single-layer film deposited over the quartz substrate without using H₂O, and curve 315 illustrates the AlF₃ single-layer film deposited over the quartz substrate using H₂O. For an ideal AlF₃ single-layer film, a wave-shape of the spectral transmission scan is above that of the uncoated substrate with its minima in transmission approaching the spectral transmission line of the uncoated substrate.

When local spectral minima (e.g., minima 320 of curve 310 and minima 325 of curve 315) are close to the spectral line of the “no coating” curve, the AlF₃ single-layer film has a low loss. Conversely, as the local minima move below the spectral line of the “no coating” curve, the loss of the AlF₃ film increases. A low-loss condition is desirable for most UV coatings.

Curve 315 illustrates that using H₂O process gas in applying the AlF₃ film moves the spectral minima 325 substantially closer to the spectral transmission of the uncoated substrate as compared to curve 310, which illustrates a similar AlF₃ film applied without the H₂O process gas. As a result, the coating applied with H₂O process gas exhibits a much lower loss condition. The addition of water to the processing environment for AlF₃ single-layer film can yield a low-loss film, which is desirable for manufacturing UV coatings.

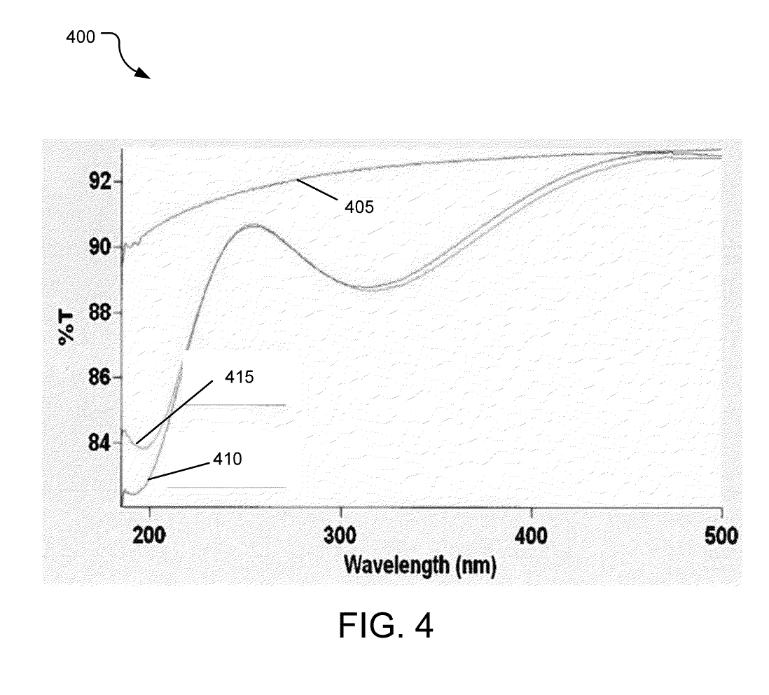

FIG. 4 illustrates an example spectral transmission scan 400 of LaF₃ single-layer films deposited over a fused quartz (i.e., silica) substrate using a water-assisted ion beam sputter deposition system. During the deposition of the LaF₃ single-layer film, H₂O vapor flows through an ion source at about 10-20 sccm. The deposited LaF₃ film thickness is about 40-60 nm.

Curve 405 illustrates the spectral transmission of the uncoated quartz substrate, curve 410 illustrates the LaF₃ single-layer film deposited over the quartz substrate without using H₂O, and curve 415 illustrates the LaF₃ single-layer film deposited over the quartz substrate using H₂O. For an ideal LaF₃ single-layer film, a wave-shape of the spectral transmission scan is substantially below that of the uncoated substrate with its maxima in transmission approaching the spectral transmission line of the uncoated substrate.

When the curves 410, 415 are close to the curve 405, the LaF₃ single-layer film has a low loss. Conversely, as the curves 410, 415 move away from the curve 405, the loss of the LaF₃ single-layer film increases. A low-loss condition is desirable for most UV coatings. While both the curves 410, 415 exhibit high losses over the entire depicted wavelength range, at the lower end of the range (e.g., within about 190-230 nm), the curve 415 illustrates significantly less loss than the curve 410. As a result, addition of water to the processing environment for LaF₃ single-layer film can yield less loss, which may be desirable for manufacturing UV coatings.

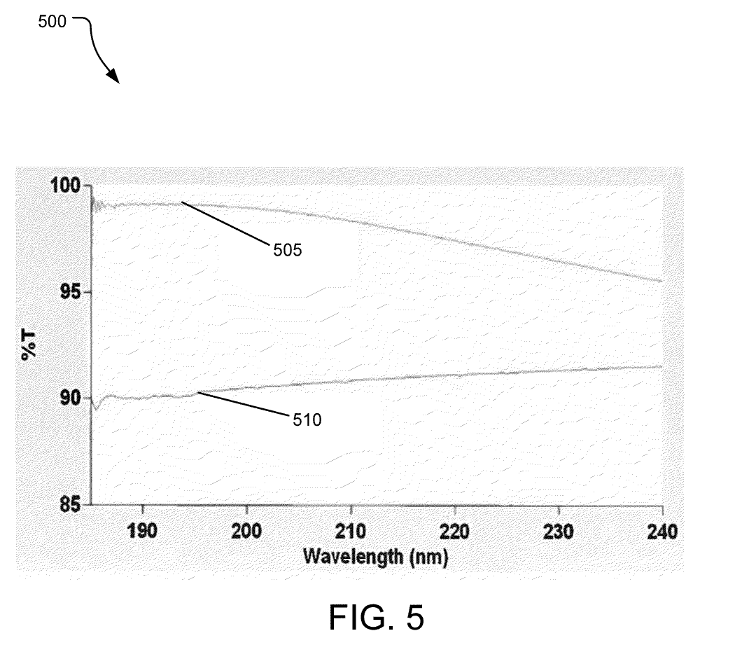

FIG. 5 illustrates an example spectral transmission scan 500 of an AlF₃/LaF₃ AR coating deposited on both sides of a fused quartz (i.e., silica) substrate using a water-assisted ion beam sputter deposition system. The transmission for the example AlF₃/LaF₃ AR coated substrate (illustrated by curve 505) is greater than about 99.0% at about 193 nm, which is significantly improved from the approximately 90% transmission of the “uncoated” silica substrate (illustrated by curve 510) within the same wavelength band. Further, optical performance of the AR coating may be particularly relevant around one or both of the 193 nm and 248 nm wavelengths, which correspond to excimer laser applications.

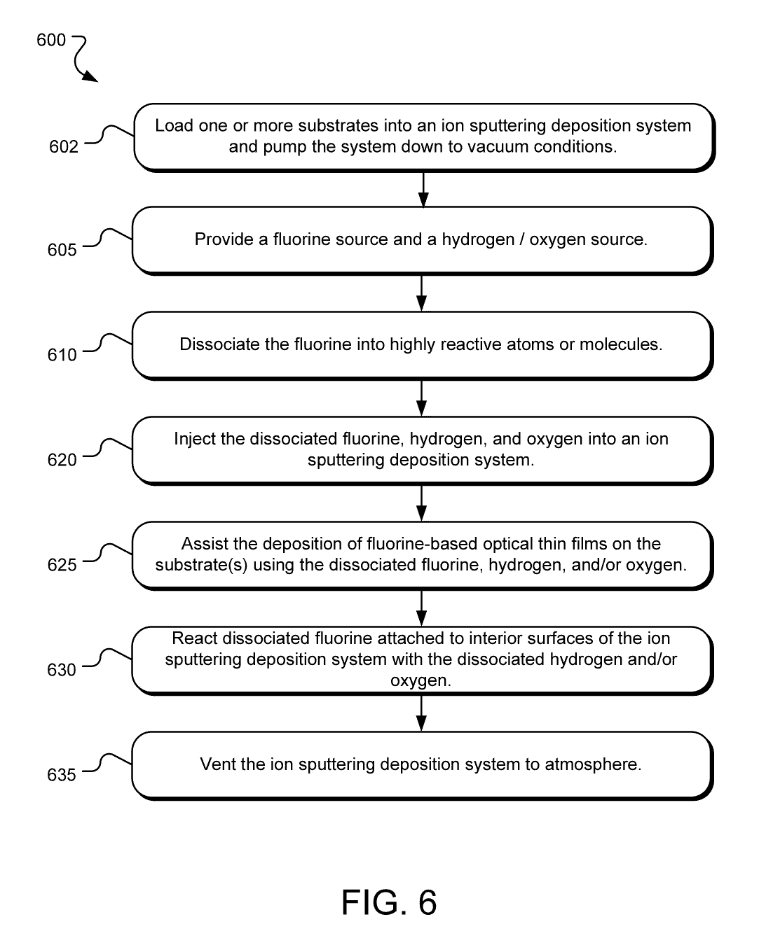

FIG. 6 illustrates example operations 600 for assisting the deposition of fluorine-based optical thin films using dissociated fluorine and one or both of hydrogen and oxygen. A loading operation 602 loads one or more substrates into an ion sputtering deposition system and pumps the system down to vacuum (or near vacuum) conditions. A providing operation 605 provides a fluorine source and a hydrogen/oxygen source. The fluorine source may be a gaseous fluorine carrier (e.g., F₂, NF₃, and CF₄). The hydrogen/oxygen source may be a gaseous hydrogen/oxygen carrier (e.g., H₂O).

A dissociating operation 610 dissociates the fluorine in the provided fluorine source into highly reactive atoms or molecules. For example, the gaseous fluorine carrier may be dissociated into more reactive atomic or radicalized molecular constituents (e.g., F—, NF—, and NF₂—). In some implementations, the dissociating operation 610 also dissociates the hydrogen and/or oxygen in the provided hydrogen/oxygen source into highly reactive atoms or molecules. For example, the gaseous H₂O may be dissociated into more reactive atomic or radicalized molecular constituents (e.g., HO—, and O—). In one implementation, the dissociating operation 610 is accomplished using a remote ICP (inductively coupled plasma) source.

An injecting operation 620 injects the dissociated fluorine, hydrogen, and/or oxygen into an ion sputtering deposition system. The fluorine, hydrogen, and/or oxygen source is introduced into the system under vacuum (or near vacuum). The ion sputtering deposition system focuses an ion beam on a metal-fluoride compound target. The ion beam sputters a plume of metal-fluoride material from the target and directs it toward a substrate. The plume of metal-fluoride material is used to create fluorine-based optical films (e.g., GdF₃, MgF₂, LaF₃, AlF₃, HfF₄, YF₃, and LiF₃) on the substrate.

An assisting operation 625 assists the deposition of the fluorine-based optical films on the substrate(s) with the dissociated fluorine, hydrogen, and/or oxygen. There may be a stoichiometric reduction of fluorine in the deposited film(s) as compared to a fluorine-based target material. The phenomenon may be caused by a differential sputtering of material constituents from the target surface that results in a depletion in fluorine in the resulting deposited film and thus contributes to optical losses in the deposited thin film in the ultra-violet range. The dissociated fluorine provides additional fluorine to the ion sputtering deposition system, which may help to obviate the aforementioned deficiency of fluorine concentration in the deposited film stoichiometry.

In one example implementation, a single layer fluorine-based thin film with low losses in the 150-200 nm UV wavelength spectral line range is produced using operations 600. In another example implementation, a multi-layer stack of high and low index fluorine-based thin films (e.g., AlF₃/LaF₃ and MgF₂/LaF₃) is produced using operations 600. The multi-layer stack of high and low index fluorine-based thin films may have a high-transmission, low-loss AR coating on one or both sides of a substrate and produce transmission greater than 99.0%. In various implementations, the aforementioned transmission efficiency may be accomplished before or after UV curing the fluorine-based thin films.

A reacting operation 630 reacts dissociated fluorine attached to interior surfaces of the ion sputtering deposition system with the hydrogen and/or oxygen. For example, the dissociated F-atoms bond with the hydrogen component of the hydrogen/oxygen carrier to form volatile HF concurrently with assisting operation 625 and prior to venting the sputter deposition system to atmosphere. The volatile HF may then be consumed as a fluorine source into the ion beam, sputter plume, and/or fluorine-based thin-films on the substrate assembly prior to venting operation 635.

The venting operation 635 vents the ion sputtering deposition system to atmosphere. The venting operation 635 enables the substrate with the fluorine-based optical film(s) to be removed from the ion sputtering deposition system and/or a new substrate to be inserted into the ion sputtering deposition system for deposition of fluorine-based optical film(s). The reacting operation 630 reduces that quantity of F— atoms adhered to interior surfaces of the ion sputtering deposition system that react with atmospheric air to form highly-toxic HF gas. As a result, venting operation 635 may be performed without posing a danger to nearby personnel.

In an example implementation, the venting operation 635 is performed with two vent-purge cycles and peak transient HF concentrations significantly less than 1 ppm (as compared to 1-3 peak HF ppm when no hydrogen/oxygen carrier is used).

The logical operations may be performed in any order, adding or omitting operations as desired, unless explicitly claimed otherwise or a specific order is inherently necessitated by the claim language. The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
depositing an ion beam sputtered metal-fluoride coating on a substrate in the presence of dissociated fluorine and at least one of hydrogen and oxygen.

2. The method of claim 1, wherein the dissociated fluorine and at least one of the hydrogen and the oxygen assist the depositing operation.

3. The method of claim 1, further comprising:
sputtering metal-fluoride material from a target onto the substrate using an ion beam.

4. The method of claim 3, wherein the target is made of one or both of a metallic alloy and a metal-fluoride.

5. The method of claim 3, wherein the dissociated fluorine and the at least one of hydrogen and oxygen assist the sputtering operation.

6. The method of claim 1, further comprising:
injecting the dissociated fluorine and the at least one of hydrogen and oxygen into an enclosure within which the depositing operation occurs.

7. The method of claim 1, wherein the dissociated fluorine becomes a part of the metal-fluoride coating during the depositing operation.

8. The method of claim 3, wherein the dissociated fluorine reacts with one or both of the substrate and the target during the depositing operation.

9. The method of claim 1, wherein one or both of the hydrogen and the oxygen are one or more of dissociated, in a gaseous state, and in the form of water vapor.

10. The method of claim 6, wherein the injecting operation is further performed using one or more of Ar, Ne, He, Kr, and Xe combined with the dissociated fluorine and the at least one of hydrogen and oxygen.

11. The method of claim 1, wherein the dissociated fluorine reacts with the hydrogen to form hydrogen fluoride and the hydrogen fluoride is consumed at least in part by the depositing operation.

12. The method of claim 11, further comprising:
exhausting at least part of the hydrogen fluoride not consumed by the depositing operation.

13. The method of claim 1, wherein the metal-fluoride coating is an optical coating.

14. The method of claim 1, wherein the metal-fluoride coating causes a surface roughness increase of less than 10 Å RMS.

15. The method of claim 1, wherein the metal-fluoride coating includes an oxygen content of between 0.1% and 20%, by volume.

16. A metal-fluoride coating ion beam sputtered onto a substrate in the presence of dissociated fluorine and at least one of hydrogen and oxygen, wherein the ion metal-fluoride coating has a surface roughness increase of less than 10 Å RMS.

17. The metal-fluoride coating of claim 16, wherein the dissociated fluorine becomes a part of the metal-fluoride coating.

18. The metal-fluoride coating of claim 16, wherein one or both of the hydrogen and the oxygen are one or more of dissociated, in a gaseous state, and in the form of water vapor.

19. The metal-fluoride coating of claim 16, wherein the metal-fluoride coating is an optical coating.

20. The metal-fluoride coating of claim 16, wherein the metal-fluoride coating includes an oxygen content of between 0.1% and 20%, by volume.

21. An ion beam sputtering system comprising:
a process gas source that injects dissociated fluorine and at least one of hydrogen and oxygen into an enclosure; and
a substrate within the enclosure that receives a sputtered metal-fluoride coating.

22. The ion beam sputtering system of claim 21, further comprising:
a target from which metal-fluoride material is sputtered by an ion beam.

23. The ion beam sputtering system of claim 22, further comprising:
ion source that generates the ion beam directed at the target.

24. The ion beam sputtering system of claim 22, wherein the target is made of one or both of a metallic alloy and a metal-fluoride.

25. The ion beam sputtering system of claim 21, wherein the dissociated fluorine becomes a part of the metal-fluoride coating.

26. The ion beam sputtering system of claim 22, wherein the dissociated fluorine reacts with one or both of the substrate and the target.

27. The ion beam sputtering system of claim 21, wherein one or both of the hydrogen and the oxygen are one or more of dissociated, in a gaseous state, and in the form of water vapor.

28. The ion beam sputtering system of claim 21, wherein the process gas source further injects one or more of Ar, Ne, He, Kr, and Xe combined with the dissociated fluorine and the at least one of hydrogen and oxygen into the enclosure.

29. The ion beam sputtering system of claim 21, wherein the dissociated fluorine reacts with the hydrogen to form hydrogen fluoride and the hydrogen fluoride is consumed at least in part by the metal-fluoride coating.

30. The ion beam sputtering system of claim 29, further comprising:
exhausting at least part of the hydrogen fluoride not consumed by the metal-fluoride coating.

31. The ion beam sputtering system of claim 21, wherein the metal-fluoride coating is an optical coating.

32. The ion beam sputtering system of claim 21, wherein the metal-fluoride coating has a surface roughness increase of less than 10 Å RMS.

33. The ion beam sputtering system of claim 21, wherein the metal-fluoride coating includes an oxygen content of between 0.1% and 20%, by volume.
